(19) United States
(12) Patent Application Publication
(10) Pub. No.: US 2017/0136807 A1
(43) Pub. Date: May 18, 2017

(54) User hand-colored temporary tattoos and pens

(71) Applicant: Caroline Kilmer, Towaco, NJ (US)

(72) Inventor: Caroline Kilmer, Towaco, NJ (US)

(21) Appl. No.: 14/944,678

(22) Filed: Nov. 18, 2015

(51) Int. Cl. B44C 1/175; B32B 37/14; B32B 38/00; B32B 37/12

(52) U.S. Cl. CPC B44C 1/1754; B32B 37/12; B32B 37/14; B32B 38/0004; B32B 2405/00; B32B 2451/00

(57) ABSTRACT

A method enables a user to apply their own artistic input to a temporary tattoo design (TTD). The TTD is pre-printed on a substrate sheet which includes a synthetic oil which allows for: ease of coloring as the gel pen inks glide easily across the paper; transfer onto the skin with high-quality and vivid color results; and increased longevity of the temporary tattoo. The user first colors in the TTD with gel pens specifically designed and tested for transference onto the skin. Second, an adhesive coating is applied to the colored TTD. The colored TTD is transferred to the skin by placing the colored TTD with adhesive face-down on skin, slightly moistening the substrate with water and then removing the backing sheet. The synthetic oil added to the tattoo transfer sheet enables the colored temporary tattoo to remain on the skin for five to ten days.

### CROSS-REFERENCE TO RELATED APPLICATIONS

N/A

### STATEMENT REGARDING FEDERALLY SPONSORED RESEARCH OR DEVELOPMENT (IF APPLICABLE)

N/A

### REFERENCE TO SEQUENCE LISTING, A TABLE, OR A COMPUTER PROGRAM LISTING COMPACT DISC APPENDIX (IF APPLICABLE)

N/A

### BACKGROUND OF THE INVENTION

The present invention relates generally to the decoration of human skin, and specifically to user, hand-colored temporary tattoos for adhesion to human skin.

### SUMMARY OF THE INVENTION

Broadly, the present invention is based on the idea of enabling a user to hand-color pre-printed artwork with gel pens and then transfer the hand-colored artwork onto the skin's surface. The novelty lies in the fact that the user is able to apply their own artistic touch to a temporary tattoo by hand-coloring the image with gel pens in glitter, metallic and standard colors and then transfer their hand-colored artwork onto the skin's surface with high quality results.

Furthermore, all pens and ink marketed for the product/process will be specifically tested to meet Food and Drug Administration (FDA) direct dermal contact regulations so that the pre-printed hand-colored artwork can be transferred to the skin with no fear of reaction, infection or skin irritation.

Additionally, the addition of a synthetic oil to the transfer paper enables the transfer paper to hold ink in a manner that allows the user to easily color in the temporary tattoo drawings. Furthermore, the transfer paper with the addition of a synthetic oil enables the gel pen inks to be transferred smoothly onto the skin's surface without smearing, and with vivid, high-quality color results. Finally, the addition of the synthetic oil to the transfer paper prolongs the longevity of the the temporary tattoo on the skin's surface.

Tattooing, or adorning the body with permanent imagery, has been in existence dating back as early as the Neolithic error. People have placed imagery on their bodies across cultures and throughput the world for many reasons including, but not limited to, for religious purposes, for statements in war, and for purposes of self-expression. The first documented professional tattoo artist in the USA began tattooing soldiers in 1861 in Boston, Mass. Since the late 1970's tattoos have become a part of mainstream culture and continue to rise in popularity. According to a 2012 Harris Pole, 21% of Americans now have tattoos or 45 million people. Just as the number of people who are getting tattoos is rising, so is the number of people who are getting them removed. Removing tattoos is both painful and expensive.

A Temporary tattoo is a non-permanent image on the skin which resembles a real-tattoo. Temporary tattoos were developed as a means to ornament one's skin without a long-term commitment, major investment, or a painful application. Temporary tattoos are made of paper, ink and/or dye, and glue and typically remain on the skin for a few days. Temporary tattoos have been printed and manufactured since the turn of the 20th century. The quality of temporary tattoos has improved dramatically over the last 100 years.

There are several ways to produce temporary tattoos. Temporary tattoos can be hand painted, drawn or airbrushed directly onto the skin; however, most of the time they are transferred onto the skin from a substrate. The ladder approach enables a person to apply pre-printed imagery onto their skin and requires no artistic skills.

The imagery is usually printed in ink or dye onto a special kind of paper coated with a transfer film which allows the artwork to be transferred off such paper when the paper becomes slightly moist. Once the substrate is moistened the special coated paper is removed, and the artwork that was on the piece of paper is now adhered on the skin's surface.

The above described temporary tattoos are often made by an inkjet or screen-printing process. In the preferred screen-printing process, stencils are used to print an image onto a special paper. The stencils are made from nonporous paper or plastic coated with lacquer, gelatin or a combination of glue and a heavy-ink substance. A silk screening stencil process is used so that the ink only touches the paper in those areas where the imagery appears. Such a process stops a clear coating from appearing on the skin where there is no imagery so the temporary tattoo looks more like a real tattoo.

Most commonly offered temporary tattoos are limiting in that the user has no artistic input into the tattoo imagery. A user's creative input is limited by the preprinted tattoos that the market has to offer, and the location where they choose to place the imagery on their body.

There are products on the market which allow one to create their own tattoos using inkjet printers to print digital imagery onto a coated release sheet, cover the printed image with an adhesive, and then transfer such imagery and the adhesive onto the skin's surface when the release sheet is dampened. There are issues of quality and safety related to these inkjet printer temporary tattoo kits. The quality of inkjet tattoos is subpar because inkjet home and office based printing, does not compare to the professional printing presses. A more potentially concerning issue is the inks used in standard home and office printers are not tested to meet FDA's regulations for direct dermal contact and therefore may not be safe for skin application.

Inkjet transfer temporary tattoo papers do enable a user to create or use a digital image for transference onto the body. If creating a digital image from scratch, the user must have fairly high artistic and technical skills to design a tattoo that is worthy of displaying on the body: otherwise, the user is limited by imagery they can find online. Furthermore, user-created inkjet printer tattoos are of poor production quality and may be unsafe for application. Although inkjet printer temporary tattoo paper is not marketed or advertised for creating one's own tattoos via hand-drawing, one could hand-draw on the temporary tattoo transfer paper that is currently on the market and transfer such hand drawings onto the skin. The issues however are 1) a consumer is unlikely to draw the conclusion that one could hand-draw on the tattoo transfer paper to create an image to transfer onto the skin, 2) the tattoo transfer paper does not easily accept pen ink and the quality of the transfer of such pen ink onto the skin is subpar, 3) inks that consumers use to draw on the tattoo transfer paper may not be safe for transference onto the skin, 4) one must have very high artistic skills to draw a tattoo on temporary tattoo transfer paper, and 5) these temporary tattoos would only last for a few days.

The present invention concept stemmed off an extremely popular trend in the market place—adult coloring books geared toward adults. In such books, the user colors—in sophisticated and intricate designs. Coloring gives adults a break from the screen, and the chores and responsibilities of everyday life. Many people report the process of coloring to be meditative and relaxing. The present invention offers a user the ability to have tremendous input into the artwork they are placing on the skin's surface. The hand-colored temporary tattoo product, would enable a user to give their own artistic input into a tattoo design by 1) coloring a line drawing with inks specifically tested for safe application onto the skin, and 2) enabling the user to have further artistic input through a choice of collaging larger and smaller tattoos onto the skin in their preferred arrangement, and finally, 3) many users may find the process of coloring the temporary tattoos meditative, relaxing and rewarding.

The quality of the printing/production of the original line-drawing tattoo ink and/or foils, the tattoo transfer paper, with an added synthetic oil, designed for the purpose of A) holding gel pen inks, B) transferring the hand-colored artwork onto the body, and C) prolonging the longevity of the temporary tattoo on the body, and the gel pen inks specifically designed and tested for this product/process all ensure high-quality results. Furthermore, inks designed in standard, metallic and glitter options give more choice to the consumer with excellent and pleasing results.

The tattoos are simple to color, and safe to apply, and the results are of very high quality.

The synthetic oil on the tattoo tattoo transfer paper, the adhesive, the inks or foils used to print the original line artwork, and pen inks marketed for the product/process will be specifically tested to meet with FDA dermal contact regulations so that the preprinted hand-colored artwork can be transferred to the skin with no fear of reaction, infection or skin irritation.

### BRIEF DESCRIPTION OF THE SEVERAL VIEWS OF THE DRAWING

FIG. 1 is a linear dimensional view of preprinted artwork on a coated release sheet, with an added synthetic oil, covered by a protective removable plastic shield to protect the preprinted artwork.

FIG. 2 is a linear dimensional view of the adhesive film on a backing sheet.

FIG. 3 is a view of gel pens in standard, metallic, and glitter colors.

FIG. 4 is a view of a user removing the plastic shield from the preprinted artwork shown in FIG. 1.

FIG. 5 is a view of a user coloring in a preprinted temporary tattoo image (with plastic shield removed as shown in FIG. 4), with the gel pens as shown in FIG. 3.

FIG. 6 is a linear dimensional view of the hand-colored artwork of FIG. 5, with the adhesive film being adhered to the hand-colored artwork and transfer sheet, to create a transfer sheet/hand-colored artwork/adhesive film layer. The adhesive layer on-top of the artwork will enable the user to hold the temporary tattoo steady and in place on the skin's surface in a later step in the process, when the hand-colored artwork is being transferred off of the transfer sheet onto the skin's surface.

FIG. 7 is a linear dimensional view of the tattoo transfer sheet/hand-colored image/adhesive film layer of FIG. 6, being cut by a user with scissors to remove any negative space surrounding the hand-colored preprinted artwork.

FIG. 8 is a view of the tattoo transfer sheet/cut-out hand-colored image/adhesive film layer in FIG. 6, cut-out so only the colored in artwork appears and any negative space surrounding such artwork has been completely removed, with the adhesive backing sheet completely removed and set aside.

FIG. 9 is a view of the tattoo transfer sheet/cut-out hand-colored image/adhesive film layer, applied to an arm, with the adhesive side face-down on skin, followed by hand-colored image, followed by tattoo transfer sheet last, with the tattoo transfer backing sheet partially removed to reveal the resultant hand-colored temporary tattoo.

FIG. 10 is a view of the tattoo shown in FIG. 6, with the backing sheet completely removed. This is a full view of the hand-colored artwork applied to an arm.

### DETAILED DESCRIPTION OF THE INVENTION

Numerous objects, features and advantages of the present invention will be readily apparent o those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings.
a. The invention is capable of other embodiments and of being practiced and carried out in various ways. Also, the phraseology and terminology employed herein are for the purpose of description and should not be regarded as limiting.
b. Therefor the object of the present invention is to provide a body art transfer device that retains, protects, and transfers a printed design from a substrate onto a person's skin.
c. Another object of the body art transfer device is to provide a means to hand-color a piece of artwork printed on a substrate with pens specifically manufactured and tested for safe and durable transference onto the skin.
d. Another object of the body art transfer device is to provide preprinted artwork printed on the substrate, in which the substrate is specifically designed for ease of coloring and holding the ink in such a manner that both the gel pen ink and original pre-printed artwork, transfer onto the skin's surface with high quality results.
e. Another object of the design is to provide preprinted line artwork that can be hand-colored, in which both the ink from the original artwork printed on the substrate and the ink from the pens used to hand-color the artwork temporarily remains upon a person's skin.
f. Another object of the body art transfer device is to provide a printed design that can be hand-colored with gel pens that can be transferred onto the skin and then removed readily from a person's skin when desired.
g. Another object of the body art transfer device is to provide a printed design that can be hand-colored with gel pens that avoids damaging a person's skin.
h. Another object of the body art transfer device is to provide a printed design that may be hand-colored, in a broad range of colors and kinds of inks including but not limited to glitter, metallic and standard inks.
i. Another object of the body art transfer device is for the device to use various gel pen inks which dry properly on the substrate and transfer effortlessly and without imperfections onto the skin.
j. Another object of the body art transfer device is to provide a substrate which includes a synthetic oil, of which the synthetic oil addition enables ease of coloring, the high quality transfer of the hand-colored artwork to the skin, and a prolonged longevity of the temporary tattoo on the skin's surface.
k. Another object of the body art transfer device is for the device to provide an adhesive layer which can be manually applied to the hand-colored artwork and which enables the artwork to remain steady and in place on the body when the hand-colored artwork is being transferred from the substrate to the skin's surface, so that no smearing of the hand-colored artwork results in the transfer process.
l. And lastly, another object of the body art transfer device is to provide a water-resistant layer that serves as a protective barrier to the hand-colored artwork and protects the original artwork and user applied gel inks from easily washing off. The user applied adhesive layer molecularly bonds with the original printed artwork and the user-applied gel pen inks. The addition of the synthetic oil on the tattoo transfer sheet acts as a coupling agent to further improve the bond of the user-applied adhesive with the inks. The bond formed between the adhesive, inks and synthetic oil protects the artwork from easily washing off the skin and as a result the temporary tattoo can remain on the skin for five-ten (5-10) days.
m. The gel pens, preprinted tattoo line artwork, and adhesive sheets that are a part of this invention may be kitted together within a package or may be displayed separately either on-line or in brick-and mortar-locations.

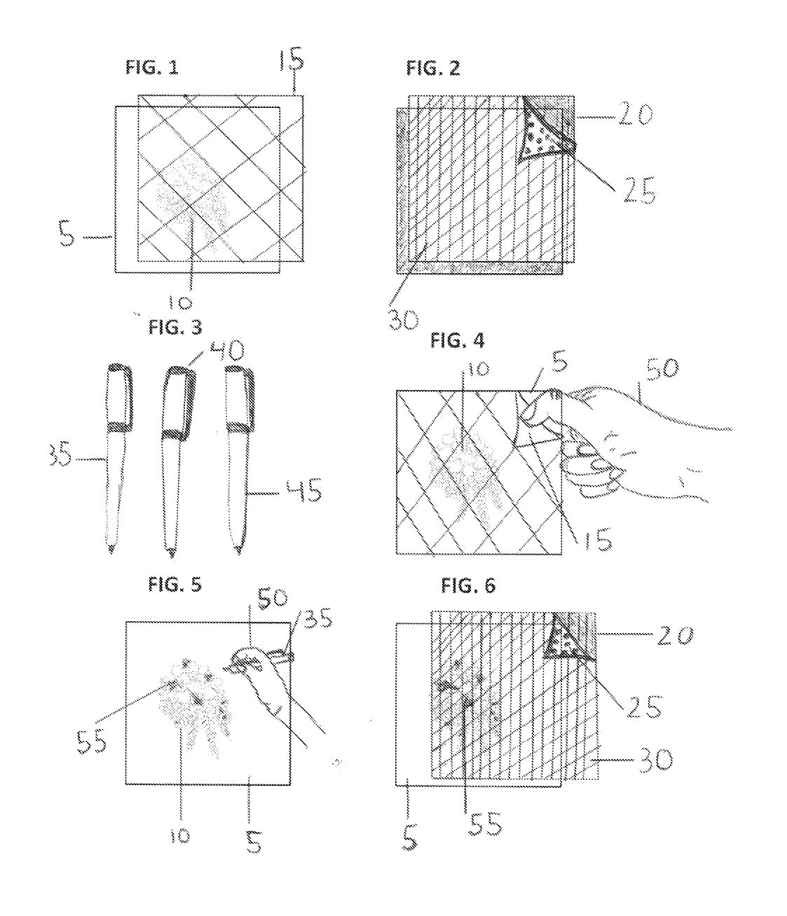

Referring now to FIG. 1, pre-printed temporary tattoo artwork according to the present invention is shown at 10, printed on a coated release sheet with an added synthetic oil is shown at 5. The pre-printed temporary tattoo artwork is covered by a plastic film to protect the artwork shown at FIG. 15. The pre-printed artwork 10 will be mirrored on the coated release sheet 5 so that when it is transferred onto the skin it is properly oriented on the user's skin's surface. The synthetic oil added to the coated release sheet 5 will act as a coupling agent to further structurally bond the user-applied adhesive (described in FIG. 2) with the pre-printed artwork ink (or foils) and the user-applied gel pen inks. The molecular bond formed between the adhesive, inks/foils and synthetic oil will act as a water-protective barrier to both the original artwork and the hand-colored inks once transferred onto the skin's surface.

Referring now to FIG. 2, Film 25 is a double-sided adhesive tape, with a transparent protective backing 30 on one side and a solid protective backing 20 on the other side. Once the protective backings 20 and 30 is removed, and film 25 is attached to image 10 and release sheet with added synthetic oil 5. An adhesive shown at 25 is face-down on a release sheet shown at 20.

Referring now to FIG. 3, Three kinds of pens are shown with three different kinds of inks: metallic inks 35, glitter inks 40, standard inks 45. Although only one pen of each ink type are shown, the current invention will have multiple colors available in each kind of ink. All inks will be tested to meet the FDA regulations for direct dermal contact.

Referring now to FIG. 4, the plastic film 15 is removed by the user's hand 50 from the coated release sheet with added synthetic oil 5, so that the pre-printed artwork 10 may be colored in by user and adhered to the skin.

Referring now to FIG. 5, the user 50 is hand-coloring pre-printed artwork 10 on coated release paper with added synthetic oil 5 using gel pen 35, 40 and 45 in multiple colors, to create hand-colored artwork 55. Coated release paper with added synthetic oil 5 is specifically designed to hold inks, and for ease of coloring. The addition of the synthetic oil to the coated release paper 5 enables the pens designed for this invention to easily glide across the coated release sheet, and additionally helps to retain the inks for high quality transference to the skin.

Referring now to FIG. 6, A transparent protective backing 30, with adhesive film 25 still adhered to the protective backing layer 30, is peeled away from protective backing 20, and applied to coated release sheet with added synthetic oil 5 on top of hand-colored artwork 55 to create the layers: coated release sheet with added synthetic oil 5/hand-colored artwork 55/adhesive film 25/protective backing 30. The user must firmly press and rub the transparent protective backing 30, so that the adhesive coating 25 transfers off the protective backing layer 30 onto the hand-colored artwork 55. Adhesive film 25 forms a sticky layer over hand-colored artwork 55. The adhesive sticky layer 25 will enable the user to hold the temporary tattoo in place on the skin in a later step in the process when the user is transferring the hand-colored artwork onto the skin's surface. Both the adhesive film 25 and protective backing 30 are transparent so the user may see their hand-colored pre-printed artwork 55 when the adhesive film is placed on top of it. When firmly applied to the hand-colored artwork, the adhesive film 25 structurally bonds with pre-printed artwork and the user-applied gel pen inks. The synthetic oil added to the coated release sheet 5 serves as a coupling agent to further bond the user applied adhesive with the inks, and in so doing further prolongs the longevity of the temporary tattoo on the skin.

The adhesive film 25, the ink and/or foils used in the original line printed artwork 55, the synthetic oil added to the coated release sheet 5, and all inks used in the pens 35, 40 and 45 will be tested for safe application to the skin.

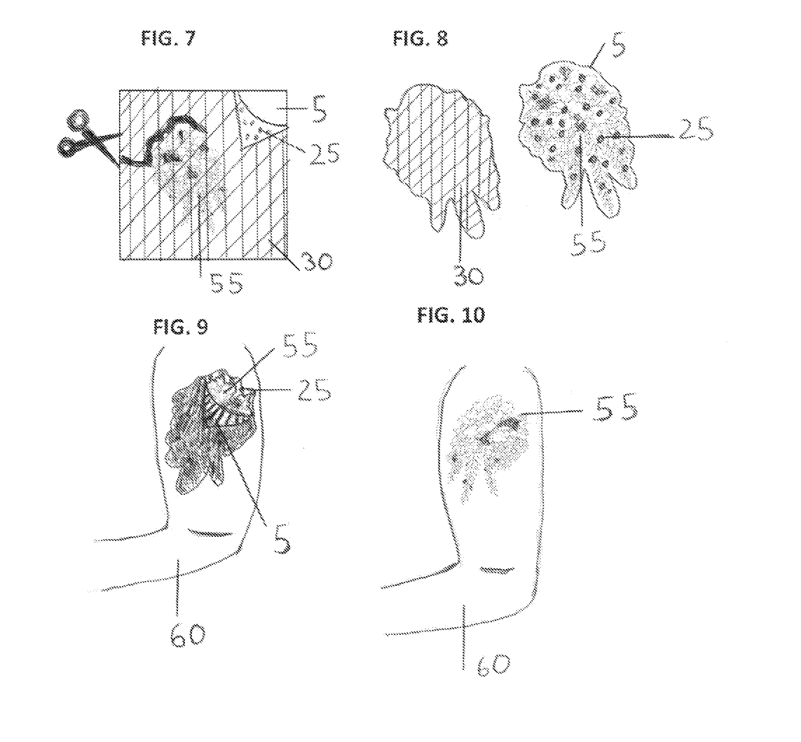

Referring now to FIG. 7, A user must cut away any areas surrounding the tattoo that are blank so that only the hand-colored artwork 55 remains. This is an important step to ensure that the temporary tattoo looks more realistic on the user's skin. Otherwise a clear coating would surround the tattoo on the skin making the temporary tattoo appear less like a real tattoo. Most often, the preprinted artwork provided will be fairly contiguous and contain very little negative space within the design. This will ensure that the artwork is easy to cut out, and that there is not a lot of negative space within the artwork where a clear adhesive coating would exist with no hand-colored artwork underneath it. The denser the artwork, the more realistic the tattoo will look.

Referring now to FIG. 8, the user takes the cut-out, hand-colored artwork 55 with the following layers: coated release sheet with synthetic oil 5/cut out hand-colored artwork 55/adhesive film 25/protective backing 30, and removes the protective backing 30.

Referring now to FIG. 9, the user takes the coated release sheet with synthetic oil 5/cut out hand-colored artwork 55,/adhesive film 25, and places it on the skin (here shown as arm 60); adhesive film 25 face-down on the skin, followed by hand colored artwork 55, followed by coated release sheet at the very back. The user then presses down on the coated release sheet 5 to hold the temporary tattoo in place, moistens coated release sheet 5 with a slightly dampened cloth or sponge, and holds slightly dampened cloth or sponge on the coated release sheet for about 30 seconds being careful not to shift the temporary tattoo around. The user than begins to peel back the coated release sheet. FIG. 9 shows the coated release sheet partially peeled back to reveal the resultant hand-colored temporary tattoo on the skin's surface.

Referring now to FIG. 10, after the coated release sheet 5 has been slightly moistened for about 30 seconds, the release sheet is peeled away, and the adhesive film 25, and hand-colored artwork 55 is transferred onto the skin resulting in a vibrant, hand-colored, high quality temporary tattoo on the skin's surface. The inks 35, 40 and 45 provided produce a shiny, shimmering and/or glittery finish. Because the original artwork 10 provided on the coated transfer sheet 5 is mirrored, the hand-colored artwork 55 when transferred onto the skin, results in the proper orientation on the body.

1. A method of attaching a high-quality, preprinted artwork in the form of a temporary tattoo that is hand-colored, to a human skin, comprising the steps of:
providing a preprinted ink mirrored artwork on a coated release sheet with an added synthetic oil, the coated release sheet of which is specifically designed to hold the preprinted inks in a manner that enables a user to easily hand-color the preprinted artwork with a plurality of gel pen inks, and provides the user the ability to transfer the combined hand-colored and the original preprinted artwork onto the human skin with high quality results to create a temporary tattoo;
providing a releasable adhesive film having a backing sheet on either side of the adhesive film,
covering the hand-colored preprinted artwork with the adhesive film so that the hand-colored preprinted artwork is located between the film and the release sheet coating to create a combined adhesive film and hand-colored preprinted artwork and coated release sheet;
attaching the combined adhesive film and the hand-colored preprinted artwork and the coated release sheet to the human skin with the adhesive; and
removing the backing sheet from the adhesive film/hand-colored preprinted artwork/coated release resulting in a temporary tattoo on the skin's surface.

2. The method of claim 1, wherein the coated release sheet is top-coated with a synthetic oil after the original artwork is printed on the release sheet.

3. The method of claim 1, wherein the double-sided adhesive film is transferred onto the hand-colored preprinted artwork by firmly pressing and rubbing the adhesive against the hand-colored artwork. Such adhesive enables the hand-colored artwork to stay in place on the skin's surface, while the user is transferring the artwork onto the skin. Furthermore, such user applied adhesive structurally bonds with the original inks/foils on the coated release sheet, and the user applied gel pen inks to form a water-protective layer for the hand colored artwork.

4. The method of claim 1, wherein the gel pen inks developed for this invention, have been tested for safe direct dermal contact, are able to glide onto the preprinted artwork transfer paper with ease, and transfer off of the coated release sheet paper onto the skin's surface along with the preprinted artwork with high quality results.

5. The method of claim 1, wherein the gel pen inks developed for the process come in a variety of kinds of ink including glitter, metallic, and standard and of which have all been tested for safe direct dermal contact. Depending on which inks are used, such inks may produce a glittery, shimmering, shiny or matte finish.

6. The method of claim 1, further comprising the step of cutting the adhesive film/hand-colored artwork/transfer sheet to remove any negative space surrounding the image.

7. The method of claim 1, wherein the step of removing the backing sheet from the adhesive film/preprinted hand-colored artwork/coating laminate includes the step of slightly moistening the backing sheet so that the backing sheet releases from both the preprinted artwork and the hand-coloring.

8. The method of claim 1, wherein the preprinted artwork provided may come in a variety of different kinds of inks, colors, or foils or a combination thereof.

9. The method of claim 1, wherein all inks, foils, synthetic oils and adhesives being transferred to the skin's surface are tested for safe direct dermal contact.

10. A method of attaching preprinted user hand-colored artwork to the skin, comprising the steps of;
providing preprinted artwork for transference onto the skin, comprising:
a printable release coating on a backing sheet with an added synthetic oil specifically formulated to hold gel pen inks for ease of coloring, and for the ability to release such gel pen inks, and original artwork from transfer sheets onto the skin;
an image printed with inks or foils on the printable release coating;
a hypoallergenic duo-sided adhesive film that is attached to the hand-colored pre-printed artwork and to the skin

11. A method of attaching preprinted artwork that has been hand-colored by the user to human skin, comprising the steps of:
providing a release coating, with an added synthetic oil, with preprinted artwork;
providing a release coating, with an added synthetic oil, with preprinted artwork in a variety of inks and/or foils;
providing a release coating, with an added synthetic oil, which easily accepts gel pen inks;
providing an adhesive hypoallergenic film which attaches to the hand-colored preprinted artwork, so that the hand-colored artwork is layered between the coating and the film; and the adhesive holds the hand-colored artwork in place on the skin's surface while transferring such artwork to the skin.

12. The method of claim 11, wherein the user-applied adhesive layer structurally bonds with the inks/foils used to print the original artwork and the user-applied gel pen inks. The synthetic oil added to the coated release sheet acts as a coupling agent and serves to further bond the adhesives with the inks/foils, and in so doing, creates a water protective layer for the hand colored artwork on the skin's surface.

13. The method of claim 11, wherein the release sheet includes a synthetic oil and a preprinted artwork layer, that can be hand-colored with gel pen inks and a backing sheet that can be released from the original pre-printed artwork, the synthetic oil, and the hand-coloring inks after the backing sheet is slightly moistened.
